(19) United States
(12) Patent Application Publication
(10) Pub. No.: US 2009/0004395 A1
(43) Pub. Date: Jan. 1, 2009

(54) Waterborne furfural-urea modification of wood

(76) Inventors: Marc Henry Schneider, Fredericton (CA); Jonathan Greer Phillips, Fredericton (CA)

Correspondence Address: Ralph A. Dowell of DOWELL & DOWELL P.C., 2111 Eisenhower Ave, Suite 406, Alexandria, VA, 22314, US

(21) Appl. No.: 11/819,951

(22) Filed: Jun. 29, 2007

(51) Int. Cl. B05D 3/02; B01J 31/04; C08G 69/08; C08K 5/55

(52) U.S. Cl. 427/393

(57) ABSTRACT

This invention provides water-based furfural-urea resins for impregnation of same into wood in order to impart decay, mold, marine borer and termite resistance and improve moisture resistance and mechanical properties. The waterborne wood modification composition for impregnation into wood, includes water, furfural, urea, an acidic catalyst, and a buffer present in an amount to give a pH in a range from about 2.96 to about 5.13.

### FIELD OF THE INVENTION

This invention relates to water-based furfural-urea resins and methods for impregnation of same into wood in order to impart decay, marine borer and termite resistance and improve moisture resistance and mechanical properties.

### BACKGROUND OF THE INVENTION

Urea [(NH₂)₂CO] is a common organic chemical. It is a major component of urine. Reacted with formaldehyde, it forms a thermosetting polymer urea formaldehyde (UF resins and polymers). The UF polymer has been used as a wood adhesive for many years, and is still the most widely used interior plywood and particleboard adhesive. In the 1940s, a prepolymer form was used as a water-diluted wood impregnant. There were commercial companies making the urea-wood composite (one trade name was “Uralloy”). Wood so treated dried with fewer defects than untreated wood. After the urea was polymerized inside the wood, the material was harder and more fire resistant. Its color was unchanged from untreated wood.

The urea treatment of wood ceased after a few years. Probable reasons are that the prepolymer is toxic, there are limits to resin weight percent gain that restrict the property increases, UF resins are susceptible to hydrolysis by water, and there is the potential of formaldehyde release from the product.

Nonetheless, urea remains an attractive chemical for wood improvement because of its non-toxicity, cheapness and ease of use. As a result, since the 1980s the inventors have been trying to find ways to overcome the disadvantages of UF treated wood.

Furfural (C₆H₄O₂) is derived from plant material containing pentosans (five (5) carbon sugars) by acid hydrolysis. Oat hulls, sugar cane bagasse and corncobs are the major industrial sources of furfural although it also can be made from wood and bark. Hardwoods are higher in pentosans than softwoods and therefore have higher furfural yield. Birch is particularly high in pentosans and has the highest yield among wood species. Furfural is one of the breakdown chemicals of biomass in nature. It is found in foods that contain cooked or fermented sugars and it can be added to foods as a flavoring.

Furfural is usually converted into furfuryl alcohol if a resin is to be made from it because furfural alone does not resinify usefully but furfuryl alcohol resinifies easily. As an aldehyde, furfural can undergo many of the same reactions as formaldehyde. Thus it becomes a candidate for reaction with urea to make resins. In the patent and technical literature, there are many descriptions of resins made using furfural, some with urea included, but all with other major reactants such as phenol included.

There was work done on furfural-urea (FUR) resins in the early 20^{th} century (e.g. p 669-670 of The Chemistry of Synthetic Resins by Carleton Ellis, Reinhold Publishing, 1935). It was later mentioned in another textbook (p 119 of Urea-Formaldehyde Resins by Beat Meyer, Addison Wesley Publishing Company, 1979). FUR resins were mentioned as wood stabilization compounds in a 1960 article, but no data on properties or methods of preparation were mentioned (Weaver, J W, J F Neilson and L S. Goldstein. 1960. Dimensional stabilization of wood with aldehydes and related compounds. FPJ June pp 306-310).

It would be very advantageous to have a furfural-urea (FUR) resin that is free of phenols and formaldehyde and capable of being absorbed by wood in sufficient amounts to enhance the wood's mechanical properties and biodeterioration resistance.

### SUMMARY OF THE INVENTION

In accordance with one embodiment of the present invention there is provided a waterborne wood modification composition for impregnation into wood, comprising water, furfural, urea, an acidic catalyst, and a buffer present in an amount to give a pH in a range from about 2.96 to about 5.13. The acidic catalyst may be any one of maleic anhydride, phthalic anhydride, formic acid, citric acid and lactic acid. A preferred acidic catalyst is maleic anhydride.

The buffer may be any one of borax (sodium tetraborate decahydrate), sodium bicarbonate (baking soda), sodium carbonate (soda ash), and sodium formate. Soda ash is a preferred buffer.

The above mentioned compositions may be used for modifying wood by penetrating the compositions into wood, and thereafter polymerizing the composition inside the wood during drying at temperatures between about 40 C and about 100 C.

In an embodiment, the present invention provides a waterborne wood modification composition for impregnation into wood, comprising

water present in an amount of about 100 parts by weight;

furfural present in an amount of about 8 parts by weight;

maleic anhydride present in an amount of about 3 parts by weight;

urea present in an amount of about 3 parts by weight; and

soda ash present in a range from about 1.5 to about 1.8 parts by weight to give the waterborne wood modification composition a pH in a range from about 2.96 to about 5.13.

### DETAILED DESCRIPTION OF THE INVENTION

The methods described herein are generally directed to wood impregnants produced from furfufural-urea-organic acid/anhydride mixtures and methods of producing wood containing polymers of these impregnants. Although embodiments of the present invention are disclosed herein they are merely exemplary.

Therefore, the specific chemical and functional details disclosed herein are not to be interpreted as limiting but merely as a basis for the claims and as a representative guide for enabling those skilled in the art to employ the present invention in a variety of manner. For purposes of instruction and not limitation, the illustrated embodiments are all directed to embodiments of wood impregnants produced from furfufural-urea-organic acid/anhydride mixtures and to methods of producing wood containing these polymerized impregnants.

As used herein, the term “about”, when used in conjunction with ranges of concentrations of constituents of various formulations or other physical properties or characteristics, is meant to cover slight variations that may exist in the upper and lower limits of the ranges of concentrations as to not exclude embodiments with concentrations slightly above or below those recited herein. It is not the intention to exclude embodiments such as these from the present invention.

As used herein, the term “resin” refers to a high molecular weight substance or pre-polymer that will subsequently be reacted to form a polymer.

The inventors have been studying furfural-urea (FUR) wood impregnation formulations in order to develop formulations that can easily be impregnated into wood and polymerized therein such that it would usefully improve wood properties such as hardness, mechanical properties and biodeterioration resistance. The inventors have been successful in developing crosslinked FUR resins with desirable properties as disclosed in copending U.S. patent application Ser. No. ______ filed concurrently herewith entitled “FURFURAL-UREA RESIN AND ADHESIVE AND THEIR METHODS OF PRODUCTION”, which is incorporated herein by reference in its entirety.

However, there are several challenges that must be overcome before useful impregnating solutions for wood can be developed. The challenges are different for high loadings than for low loadings. High loadings can potentially impart large physical property improvements and dark color. Low loadings have the potential to improve biodeterioration resistance at low cost and to impart medium brown to reddish brown color, depending upon species and loading. The present invention is directed to methods and compositions for low polymer loadings of wood.

The nature of the pores in wood makes it difficult to control the quantity of impregnation with liquids. Either the wood easily accepts liquid loading or it does not impregnate well. Wood that do not impregnate well are not useful for this technology, while wood that does impregnate has high fluid loading. Consequently, the strategy to control polymer loading is to use liquid solutions that contain polymerizable ingredients, with the rest of the solution being volatile and able to leave the wood after impregnation. Water is an excellent solvent for such solutions. It is the concentration of such solutions that determines the polymer weight percent gain of the wood.

Catalyzed furfural and urea mixtures containing little water react strongly and produce a hard, water-insoluble, methanol-insoluble thermosetting resin. It is known, however, that when the catalyzed furfural and urea mixtures are diluted in water and then cured, the resulting resin is soft and soluble in water and methanol and thus has no utility as a wood modifying agent.

Without being limited to any theory, it is believed by the inventors that the key function of the aldehyde is to react with the urea to produce the resin, so those skilled in the art will appreciate that many aldehydes and combinations of them may be used including acetaldehyde, propionaldehyde, n-butyraldehyde, isobutyraldehyde, n-valeraldehyde, isovaleraldehyde, n-caproaldehyde, acrolein(propenal), crotonaldehyde, gluteraldehyde and benzaldehyde.

Furfural is a preferred aldehyde for this invention because of its good reactivity, ability to form a strong polymer, relatively low volatility and because it is made from plant tissue, particularly agricultural residues. Thus it works well and comes from a renewable resource.

The inventors have discovered a furfural-urea solution in water that cures to a hard, insoluble resin in wood, producing a furfural polymer modified wood. Without being bound by any theory, it is believed that the concentration of the furfuryl-urea in the solution increases in the wood cell wall. This increased concentration facilitates polymerization and crosslinking. This water solution penetrates wood better than some copper-based preservatives or furfuryl alcohol-water solutions. Penetrability is similar to water alone. Furfural has limited solubility in water which currently defines the upper limit of concentration. The solutions used herein are of approximately maximum concentrations achievable using present knowledge.

A preferred formulation is provided in Table 2. Soda ash or borax is used for pH control. Soda ash has the advantage that it loses some of its buffering function with increased temperature. This causes soda-ash-buffered furfural-urea solutions to decrease in pH upon heating, which facilitates curing. Borax is both a buffer and an antimicrobial and anti-insect agent. Used together, these two buffers complement one another. While borax and/or soda ash is (are) preferred, other buffers may also be used including sodium bicarbonate (baking soda) and sodium formate to mention a few examples.

The solution needs to be acidic to react, but its working life becomes very short when it is too acidic. A preferred acidic catalyst is maleic anhydride. Strictly speaking, maleic anhydride is not an acid, but it does impart an acidic effect (low pH) to the formulation. Thus, as used herein, the phrase “acidic catalyst” is meant to cover maleic anhydride even though it is not an acid by definition. As mentioned above, maleic anhydride is a preferred compound to obtain the needed acidity because less of it is needed than some other true acids (like citric acid) and because it is thought to be covalently incorporated into the resin rather than just acting only as a catalyst. Alternative acidic catalysts that may be used include, but are not limited to: phthalic anhydride, formic acid, citric acid, or lactic acid which are true acids by definition. The key function of the acidic catalyst is to make the solution mildly acidic, so those skilled in the art will appreciate that many organic acids, mineral acid salts and dilute mineral acids and combinations of them may be used including dilute sulfuric acid, dilute hydrochloric acid, zinc chloride and ferric chloride.

Furfural has limited solubility in water. A minimum level of formulation in the wood is needed to obtain useful property enhancements. Therefore, the limited solubility and minimum level requires that formulation concentration in water be maximized. The formulations in Table 1 use the maximum furfural that is soluble and the amount of urea and maleic anhydride needed to react the furfural fully in the wood. The buffer is varied to produce 3 different pHs. The first formulation, pH of 5.13, is above the upper limit of pH for good curing. The second formulation, pH 3.6, cures well at a moderate production rate. The third formulation, pH 2.96, works well for high-speed production but the shelf life of the mixture is shorter than the others. If a way to increase furfural and formulation solubility in water is found, concentrations of the constituents could be increased which would lead to higher wood polymer weight percent gains. That would have advantages for some applications.

The three formulations in Table 1 have identical concentrations of furfural, urea and maleic anhydride. It was found that a practical storage life combined with useful reactivity can be achieved by adjusting the pH of the mixture to the range from about 3.4 to about 3.6 using a buffer such as soda ash or borax.

A total of forty-five (45) samples of three (3) species were treated using a full-cell process (initial full vacuum, 8 bar pressure) as will be known to those skilled in the art. Table 2 displays the average fluid loading and polymer weight percent gain for the two species. Untreated, end-matched samples were compared in swelling behavior to treated samples. The anti-swell efficiency (ASE) reported in Table 2 was calculated using these results.

TABLE 1
Waterborne FU treating formulation, parts by weight

| | | Maleic | | Soda | pH |
|---|---|---|---|---|---|
| Water | Furfural | anhydride | Urea | ash | (stabilized) |
| 100 | 8 | 3 | 3 | 1.8 | 5.13 |
| 100 | 8 | 3 | 3 | 1.6 | 3.60 |
| 100 | 8 | 3 | 3 | 1.5 | 2.96 |

TABLE 2
Some properties of wood treated with FU waterborne formulation.

| | Specific | % fluid | | |
|---|---|---|---|---|
| | gravity | loading | WPG | ASE (%) |
| Scots pine | 0.50 | 100 | 7 | 17 |
| Southern pine | 0.50 | 100 | 7 | 26 |

Samples were penetrated very well by the solution, much better than waterborne furfuryl alcohol (furfurylated) and copper salt (ACQ) preservatives. Sapwood in all species was fully penetrated with the solution and heartwood that would not be penetrated by ACQ or be furfurylated was well penetrated. The treated zone was light brown. The anti-swell efficiency (ASE) is higher than that experienced with similar concentrations of furfuryl alcohol waterborne treatments, suggesting that the effect on the wood might be greater at similar WPG.

The solution penetrated so easily that hardwood veneer could be fully penetrated with a few hours of soaking, without vacuum or pressure. When cured, this veneer had a rich, brown color.

Curing was accomplished during the drying process. A normal kiln drying schedule below the boiling point of water was used. Curing efficiencies were determined by comparing the fluid loading and concentration of theoretical solids to the polymer weight percent gain. The proportion of water produced by the polymerization reaction (30%) was measured in a separate experiment and included in the efficiency calculation. Efficiencies were in the 60% to 80% range (that is, 20% to 40% of the active ingredients of the treating solution were lost while curing). This is the same as for furfuryl alcohol-based waterborne treating solutions used to make furfurylated wood. The lower end of the range was for small blocks and the higher for larger samples. Lumber would be at the higher end of the range, or even above the range, because of its low surface-to-volume ratio compared to a small sample.

Samples of wood treated with the formulation to three (3) levels of polymer weight percent gain (WPG) and controls were placed in a moist, warm container containing forest soil and decayed wood for one year. The loss in wood substance after this exposure is given in Table 3.

TABLE 3
Decay test results of FUR treated wood

| Treatment | Samples | WPG | % wood loss |
|---|---|---|---|
| Untreated | 10 | 0.0 | 22.0 |
| Furfurylated | 10 | 25.0 | 10.5 |
| ACQ | 10 | | 3.5 |
| FUR | 10 | 4.6 | 16.3 |
| FUR | 3 | 6.7 | 10.4 |
| FUR | 4 | 8.0 | 7.0 |

The results illustrate that the treatment disclosed herein provides decay protection to wood. It indicates that this protection is better at a specific WPG than furfuryl alcohol treated wood. The FUR treating formulation was buffered with soda ash, which has no known effect on decay causing agents.

FUR formulations including borax are expected to have better decay, mold and insect attack resistance than the use FUR polymer or borax alone. It will give useful protection to wood at borax concentrations of less than 1% (based on ovendry weight of wood being treated). The furfural-urea polymer would prevent or retard water leaching of the borax, making the treatment useful for wet locations. It is contemplated that even if a combination of soda ash and borax were used as the buffer (borax at 0.5% to 1% and soda ash about 1% based on furfural by weight), the decay resistance would be improved because of the known decay-inhibiting properties of borax.

There are several advantages of the methods disclosed herein for modifying wood by impregnation of solutions containing furfural, urea, an acidic catalyst (preferably maleic anhydride) and a buffer (preferably soda ash). The method is simple and uses plant-derived chemicals as the major constituents of the solutions. The penetration is excellent and better than metal salt and furfuryl alcohol waterborne treating solutions. The wood composite material is an attractive brown color after impregnation. Substantially complete curing occurs during normal, below-water-boiling-point drying schedule and no final baking of the composite is required. The curing efficiency is high and is comparable to furfuryl alcohol-based waterborne solutions. The ASE is higher for a particular WPG than furfuryl alcohol-based treating, suggesting that other properties may also be higher for a comparable WPG. In addition, studies by the inventors show decay resistance appears to be higher than furfurylated wood at comparable WPG. Other substances that can help protect wood may be incorporated into the aqueous formulations in small amounts to boost mold and biodeterioration resistance. For example, borax may be used for this purpose).

As used herein, the terms “comprises”, “comprising”, “includes” and “including” are to be construed as being inclusive and open ended, and not exclusive. Specifically, when used in this specification including claims, the terms “comprises”, “comprising”, “includes” and “including” and variations thereof mean the specified features, steps or components are included. These terms are not to be interpreted to exclude the presence of other features, steps or components.

The foregoing description of the preferred embodiments of the invention has been presented to illustrate the principles of the invention and not to limit the invention to the particular embodiment illustrated. It is intended that the scope of the invention be defined by all of the embodiments encompassed within the following claims and their equivalents.

### References

Zeitsch, K. J 2000. The chemistry and technology of furfural and its many by-products. ACS Sugar series, 13.Elsevier Science BV. p 358.
The Chemistry of Synthetic Resins by Carleton Ellis, Reinhold Publishing, 1935 Weaver, J W, J F Neilson and L S. Goldstein. 1960. Dimensional stabilization of wood with aldehydes and related compounds. Forest Products Journal, June, pp 306-310.

Therefore what is claimed is:

1. A waterborne wood modification composition for impregnation into wood, comprising water, furfural, urea, an acidic catalyst, and a buffer present in an amount to give a pH in a range from about 2.96 to about 5.13.

2. The composition according to claim 1 wherein said acidic catalyst is selected from the group consisting of maleic anhydride, phthalic anhydride, formic acid, citric acid and lactic acid.

3. The composition according to claim 1 wherein said buffer is selected from the group consisting of borax (sodium tetraborate decahydrate), sodium bicarbonate, sodium carbonate, and sodium formate, and any combination thereof.

4. The composition according to claim 1 wherein said buffer is a combination of borax and sodium carbonate.

5. The composition according to claim 4 wherein said borax is present in 0.5 to 1% and said sodium carbonate is present in 1% based on furfural by weight.

6. The composition according to claim 1 wherein the buffer is sodium carbonate and said acidic catalyst is maleic anhydride.

7. The composition according to claim 6 wherein said water is present in an amount of about 100 parts by weight, said furfural is present in an amount of about 8 parts by weight, said maleic anhydride is present in an amount of about 3 parts by weight, said urea present in an amount of about 3 parts by weight, and said sodium carbonate is present in a range from about 1.5 to about 1.8 parts by weight to give the waterborne wood modification composition a pH in a range from about 2.96 to about 5.13.

8. The composition according to claim 1 wherein the buffer is sodium carbonate present in an amount sufficient to give the composition a pH adjusted to within a range from about 3.4 to about 3.6.

9. A method of modifying wood including penetrating the composition of claim 1 into wood, and thereafter polymerizing said composition inside the wood at temperatures between about 40 C and about 100 C.

10. A method of modifying wood including penetrating the composition of claim 5 into wood, and thereafter polymerizing said composition inside the wood at temperatures between about 40 C and about 100 C.

11. A method of modifying wood including penetrating the composition of claim 6 into wood, and thereafter polymerizing said composition inside the wood at temperatures between about 40 C and about 100 C.

12. A wood composite material treated with the composition of claim 10 which exhibits a polymer weight percent gain in a range from about 5% to about 15%.

13. The composition according to claim 1 wherein said acidic catalyst is selected from the group consisting of dilute mineral acids and mineral acid salts.

14. A waterborne wood modification composition for impregnation into wood, comprising
water present in an amount of about 100 parts by weight;
furfural present in an amount of about 8 parts by weight;
maleic anhydride present in an amount of about 3 parts by weight;
urea present in an amount of about 3 parts by weight; and
soda ash present in a range from about 1.5 to about 1.8 parts by weight to give the waterborne wood modification composition a pH in a range from about 2.96 to about 5.13.

15. A method of modifying wood including penetrating the composition of claim 14 into wood, and thereafter polymerizing said composition inside the wood during drying at temperatures between about 40 C and about 100 C.
